(19) United States
(12) Patent Application Publication
(10) Pub. No.: US 2026/0072150 A1
(43) Pub. Date: Mar. 12, 2026

(54) ULTRASONIC PHASED ARRAY SENSOR

(71) Applicant: Robert Bosch GmbH, Stuttgart (DE)

(72) Inventors: Matthias Rutsch, Leonberg (DE); Dhruvinkumar Rakesh Darji, Leonberg (DE); Saeed Arafat, Rutesheim (DE)

(21) Appl. No.: 18/813,415

(22) Filed: Aug. 23, 2024

(30) Foreign Application Priority Data
Sep. 19, 2023 (DE) 10 2023 209 060.0

(51) Int. Cl. G01S 7/521; B06B 1/06; G01S 15/931

(52) U.S. Cl. CPC G01S 7/521; B06B 1/0666; G01S 15/931; G01S 2015/932

(57) ABSTRACT

An ultrasonic phased array sensor with a multi-layer structure. At least one first layer has a membrane. At least one second layer has a piezoelectric substrate. At least one third layer has a plurality of electrical contacts. The electrical contacts are applied independently of one another on a surface of the piezoelectric substrate.

### CROSS REFERENCE

The present application claims the benefit under 35 U.S.C. § 119 of German Patent Application No. DE 102023 209 060.0 filed on September 19, 2023, which is expressly incorporated herein by reference in its entirety.

### FIELD

The present invention relates to an ultrasonic phased array sensor comprising a membrane, a piezoelectric substrate, and a plurality of electrical contacts, wherein the electrical contacts are applied independently of one another on a surface of the piezoelectric substrate.

### BACKGROUND INFORMATION

One measurement design of ultrasonic parking sensors is based on acoustic waves.

These are radiated into the inaudible range and reflected by an obstacle. An ultrasonic parking sensor receives the reflected signal and the electronics evaluate the signal using a time measurement (runtime). All ultrasonic parking sensors use a piezoelectric element to convert electrical energy into acoustic energy. However, this single element limits the range of application of the parking sensor to one direction of sound radiation. Other physical effects, such as lidar or radar, could also be used for parking sensors. However, ultrasound allows for very cost-effective production of parking sensors.

To expand the sensing range of ultrasonic sensors, ultrasonic phased array sensors are already being used in medicine (A.S. Savoia, “Design, Fabrication, Characterization, and System Integration of a 1-D PMUT Array for Medical Ultrasound Imaging,” 2021 IEEE International Ultrasonics Symposium (IUS), p. 4, 2021). These are based on a combination of individual ultrasonic transducer arrays. The direction of radiation of the ultrasound can be changed by phase-offset controlling of the individual ultrasonic transducers. This makes it possible to scan a volume using an ultrasonic phased array sensor and even to perform acoustic imaging. Air-coupled ultrasonic phased array sensors are not yet commercially available according to the current state of the art. So far, there are only research projects in this area (Jäger, D. Grosskurth, M. Rutsch, A. Unger, R. Golinske, H. Wang, S. Dixon, K. Hofmann, and M. Kupnik, “Aircoupled 40-kHz ultrasonic 2D-phased array based on a 3D-printed waveguide structure,” 2017 IEEE International Ultrasonics Symposium (IUS), p. 4, 2017; G. Allevato, M. Rutsch, J. Hinrichs, M. Pesavento, and M. Kupnik, “Embedded Air-Coupled Ultrasonic 3D Sonar System with GPU Acceleration,” 2020 IEEE SENSORS, p. 4, 2020; G. Allevato, M. Rutsch, J. Hinrichs, E. Sarradj, M. Pesavento, and M. Kupnik, “Spiral Air-Coupled Ultrasonic Phased Array for High Resolution 3D Imaging,” 2020 IEEE International Ultrasonics Symposium (IUS), p. 4, 2020; E. Verreycken, W. Daems and J. Steckel, “Passive Akustik [Passive acoustics].” Steckel, “Passive Acoustic Sound Source Tracking in 3D Using Distributed Microphone Arrays,” 2018 International Conference on Indoor Positioning and Indoor Navigation (IPIN), p. 4, 20018) and start-ups (Toposens, Toposens, 2022, https://toposens.com/autonomous-parking/). These systems have yet to be used commercially in the automotive sector. All of these systems are based on the interconnection of a plurality of piezoelectric ultrasonic transducers. Since the cost of the sensor scales with the number of ultrasonic transducers, these approaches are not suitable for a low-cost parking sensor. In addition, these systems are too large for the automotive sector and cannot be manufactured in a compact form.

Electrode separation is currently only used for surface acoustic waves (SAW) (Y.-n. YIN, W. WANG, Y.-n. JIA, X.-f. XUE and Y. LIANG, “Development of A Surface Acoustic Wave Delay Line Device for Sensing ICE,” 201913th Symposium on Piezoelectric, Acoustic Waves and Device Applications (SPAWDA), p. 4, 2019). Comb electrodes allow waves to be transmitted or received only at selected regions of the piezoelectric substrate. These SAWs are used to construct high frequency filters or delay elements, which are not part of the present invention.

The present invention presented here also differs substantially from PMUTs (piezoelectric machined ultrasonic transducers) (S. Sadeghpour, E. Zilonova, J. D'Hooge and M. Kraft, “A Novel 6 MHz Phased Array Piezoelectric Micromachined Ultrasound Transducer (pMUT) with 128 Elements for Medical Imaging,” 2021 IEEE International Ultrasonics Symposium (IUS), p. 4, 2021, A.S. Savoia, “Design, Fabrication, Characterization, and System Integration of a 1-D PMUT Array for Medical Ultrasound Imaging,” 2021 IEEE International Ultrasonics Symposium (IUS), p. 4, 2021), as here no clean room processes are used and thus costs are saved.

### SUMMARY

The functions of an ultrasonic phased array sensor with a single piezoelectric element (hereinafter referred to as piezoelectric substrate) are emulated in order to realize a novel parking sensor. In this case, the entire piezoelectric substrate is not irradiated with a large-area electrode; rather, the electrode is isolated in order to excite individual regions of the piezoelectric substrate to vibrate. This is a compact and cost-effective solution.

According to an example embodiment of the present invention, an ultrasonic phased array sensor comprising a multi-layer structure is provided, wherein at least one first layer has a membrane, at least one second layer has a piezoelectric substrate, and at least one third layer has a plurality of electrical contacts, wherein the electrical contacts are applied independently of one another on a surface of the piezoelectric substrate.

A membrane is a layer that serves as a separating layer between a medium to be measured and the sensor. Ultrasonic phased array sensors use a membrane to transmit or receive ultrasonic waves. The membrane acts, for example, as an ultrasonic transducer to convert mechanical vibrations into electrical signals.

An electrical contact comprises a connection or terminal used to establish electrical signals between the piezoelectric material and an electronic circuit that controls the ultrasonic phased array sensor. An electrical contact, for example, is suitable for generating, detecting, or processing electrical signals based on the piezoelectric properties of a substrate. These electrical contacts can be attached to the piezoelectric substrate, for example in the form of wires, contact pins, or soldered connections.

In the solution according to an example embodiment of the present invention, a plurality of regions of the piezoelectric substrate are provided with the electrical contacts, wherein the electrical contacts can be controlled independently of one another. This allows the contacted regions to be electrically controlled independently of one another and the direction of the ultrasound radiation to be controlled. In addition, the detection range of the sensor is significantly increased by the independent controlling of the contact surfaces by electrical contacts. On this basis, for example, height classifications of obstacles can be carried out.

The use of a piezoelectric substrate proposed in the present invention is a substantial component of an ultrasonic phased array sensor. A material is used that has a piezoelectric property. The piezoelectric property allows a material to generate an electrical charge when subjected to mechanical stress or deformation and, conversely, to undergo mechanical deformation when an electrical voltage is applied. For example, in the generation of ultrasonic waves, when an electrical voltage is applied the piezoelectric substrate deforms due to the piezoelectric property, and this deformation generates ultrasonic waves which propagate as sound waves. When the ultrasonic waves hit an object, these ultrasonic waves are reflected to the piezoelectric substrate, and the reflected ultrasonic waves cause a further deformation of the piezoelectric substrate which is then converted into an electrical voltage. Thus, for example the electrical voltage can be measured and evaluated to obtain information about an object, for example information about the distance of an object from the ultrasonic sensor.

In an advantageous development of the ultrasonic phased array sensor provided according to the present invention, the membrane is mechanically connected to the piezoelectric substrate.

A mechanical connection within the meaning of the present invention means that at least two components are physically connected to one another. A mechanical connection of a piezoelectric substrate to a membrane comprises various joining methods such as anodic bonding or gluing, mechanical fastening, or thermal bonding. The compound excites the membrane locally to vibrate and emits ultrasound in the free medium.

In an advantageous development of the ultrasonic phased array sensor provided according to the present invention, a radiation angle can be varied by a phase shift.

A radiation angle is an angular range in which a radiation source, for example an ultrasonic phased array sensor, radiates into the surrounding space, or receives from it. The radiation angle is a specific angle between a major radiation axis, a main axis, of the radiation source and a boundary of the irradiated region. The radiation angle can be measured for example in degrees and represented in polar coordinates for example in ultrasonic phased array sensors. The radiated sound pressure level is normalized to the maximum (normalized sound pressure level (dB)). Due to the phase shift between the array elements, the radiation direction changes.

In an advantageous embodiment of the ultrasonic phased array sensor provided according to the present invention, a radiation direction can be controlled by phase shifting.

According to an example embodiment if the present invention, a phase shift is understood to mean a targeted adjustment of the temporal orientation of the emitted or detected ultrasonic waves between the individual components of an ultrasonic grid. A change in this phase shift can be used for example to direct, focus, and control the radiation characteristics of the ultrasonic waves of a sensor. For example, precise focusing can improve the spatial resolution.

The phase shift of the individual electrical contacts is realized by electronics. These electronics comprise at least one function generator which causes a resonance of the electrical contact to oscillate. The function generator then controls a plurality of phase shifters (phi_1, phi_2, phi_3), which change a phase of the control signal. The outputs of the phase shifters are electrically connected to the individual electrical contacts. As a result, each electrical contact oscillates with a different phase and the resulting direction of radiation of the ultrasonic phased array sensor can be changed.

A radiation direction within the meaning of the present invention is a specific orientation of the ultrasonic waves emitted by the sound source of an ultrasonic phased array sensor. The energy flow of the ultrasonic waves can be precisely controlled via the radiation direction, thus having significant effects on the performance and flexibility of the sensor. The radiation direction can be controlled by a combination of radiation angle and phase shift. If, for example, the radiation angle is changed in such a way as to cause a change in the spatial propagation direction of the emitted energy, then the phase shift results in a combination of the ultrasonic waves that causes an amplification in the desired radiation direction.

For example, the ultrasonic phased array sensor can be installed in the shock absorber of a vehicle, and the radiation direction can be manipulated. In this way, for example an ultrasonic signal can be radiated at various angles.

In an advantageous embodiment of the ultrasonic phased array sensor provided according to the present invention, the ultrasonic phased array sensor comprises an obstacle height measurement by phase shift.

The solution according to the present invention makes it possible, for example, to radiate sound in a straight direction with the same application of an alternating voltage. Furthermore, the radiation direction of the ultrasonic phased array sensor can be varied, for example if an electrical phase shift is introduced. This means that an obstacle can be detected acoustically, scanned, and for example an obstacle height measurement can be carried out.

For example, the ultrasonic phased array sensor can be installed in the shock absorber of a vehicle for the obstacle height measurement. In this case, the ultrasound is initially radiated in a straight line towards an obstacle. Through the use of direct radiation, a maximal echo is received from the obstacle. To measure the height of the obstacle, the angle of the ultrasound radiation is then increased until the ultrasound misses the obstacle. As soon as the ultrasound has passed by the obstacle, a minimal receiving signal is detected and the height of the obstacle can be estimated.

In an advantageous development of the ultrasonic phased array sensor provided according to the present invention, the ultrasonic phased array sensor can be made in a variety of geometric shapes: round, rectangular, elliptical, triangular, or square.

In an advantageous example embodiment of the ultrasonic phased array sensor provided according to the present invention, the number of electrical contacts can be selected as desired.

In a further advantageous embodiment of the ultrasonic phased array sensor provided according to the present invention, the electrical contacts are divided into individual electrically separated regions, wherein each region or a plurality of individual regions can be controlled separately.

In a further advantageous example embodiment of the ultrasonic phased array sensor provided according to the present invention, the membrane offers protection against environmental influences, wherein the membrane comprises a moisture-resistant and dust-resistant material.

Furthermore, the present invention relates to the use of the ultrasonic phased array sensor for automotive applications, wherein the ultrasonic phased array sensor is designed as a parking sensor.

### SUMMARY

The ultrasonic phased array sensor according to an example embodiment of the present invention uses a piezoelectric substrate as an insert, which is divided into a plurality of regions. This allows these regions to be electrically controlled independently of one another and the direction of the ultrasound radiation to be steered.

The ultrasonic phased array sensor according to the present invention significantly increases the detection range (FOV) of the sensor. This allows a larger area or volume to be detected within a limited detection range. This provides an increased detection range compared to the related art, for example in safety-critical applications such as autonomous driving or parking, where complete environmental detection is indispensable.

Furthermore, the increased detection range of the ultrasonic phased array sensor allows for early detection of obstacles before they enter the immediate detection range. The increased detection range also allows the number of sensors required to be reduced. Furthermore, an increased detection range of an ultrasonic phased array sensor according to the present invention allows for flexible sensor placement and thus reduces the overall system complexity.

In addition, it is possible to perform a height classification of obstacles. With the aid of height classification, a more accurate detection of parking spaces can be achieved, since the sensor not only monitors the horizontal position of a parking space, but also the height of the available space. When parking, height classification helps to detect obstacles such as poles, curbs, or neighboring objects, so that parking in and leaving parking spaces can be carried out without collisions.

The present invention mentioned increases safety when parking. For example, a child directly in front of, next to, or behind the vehicle can be better recognized. The same applies to animals such as dogs, cats, and the like.

The present invention is a cost-effective option for an ultrasonic phased array sensor. Because only one piezoelectric substrate is required, both manufacturing costs and material costs are very low compared to systems with multiple piezoelectric substrates.

Because the present invention has a wide reception range (FoV) compared to the related art, the number of ultrasonic parking sensors required in vehicles can be reduced. For example, for larger vehicles (station wagons, coupes, etc.), one sensor could be installed in the middle and two more at the corners of the front or rear of the vehicle. Small cars could be equipped with only one central sensor to further reduce costs.

With current ultrasonic parking sensors, false detections occur regularly due to strong acoustic echoes from the ground. Particularly in parking garages with duplex parking spaces or on roads with rough surfaces, the sensor responds even though no obstacle is present. Using the present invention, this problem can be solved because the direction of the reflection can be checked for plausibility. This increases the overall reliability of ultrasonic parking sensors and reduces false detections.

### BRIEF DESCRIPTION OF THE DRAWINGS

Example embodiments of the present invention are explained in greater detail with reference to the figures and the following description.

FIG. 1 is a schematic representation of an ultrasonic phased array sensor in cross section, according to an example embodiment of the present invention.

FIG. 2 is a schematic representation of an ultrasonic phased array sensor, according to an example embodiment of the present invention.

FIG. 3 is a schematic representation of a sound pressure level diagram, according to an example embodiment of the present invention.

FIG. 4 is a schematic representation of a phase shifter connected to an ultrasonic phased array sensor, according to an example embodiment of the present invention.

FIG. 5 is a schematic representation of the direction of radiation of an ultrasonic phased array sensor mounted on a vehicle, according to an example embodiment of the present invention.

FIG. 6 is a schematic representation of an obstacle height measurement, according to an example embodiment of the present invention.

### DETAILED DESCRIPTION OF EXAMPLE EMBODIMENTS

In the following description of example embodiments of the present invention, identical or similar elements are denoted by the same reference signs, a repeated description of these elements in individual cases being dispensed with. The figures show the subject matter of the present invention only schematically.

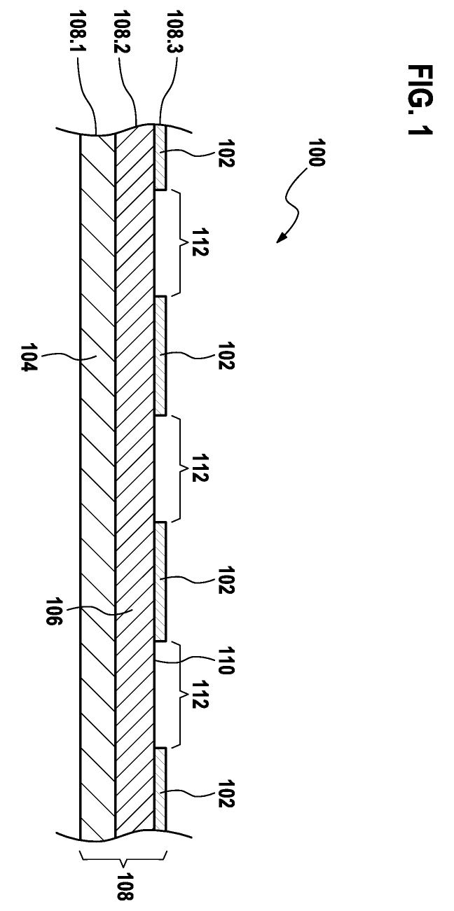

FIG. 1 shows a schematic representation of an ultrasonic phased array sensor 200 in cross section 100, which comprises a multi-layer structure 108. The multi-layer structure 108 shown in FFIG. 1 has a first layer 108.1 which is formed from a membrane 104. A second layer 108.2 has a piezoelectric substrate 106 and a third layer 108.3 has four electrical contacts 102, wherein the electrical contacts 102 are applied at a distance 112 from one another on a surface 110 of the piezoelectric substrate 106.

As an alternative to FIG. 1, further electrical contacts 102 can for example be applied to a surface 110 of the piezoelectric substrate 106, wherein the distance 112 can be selected variably.

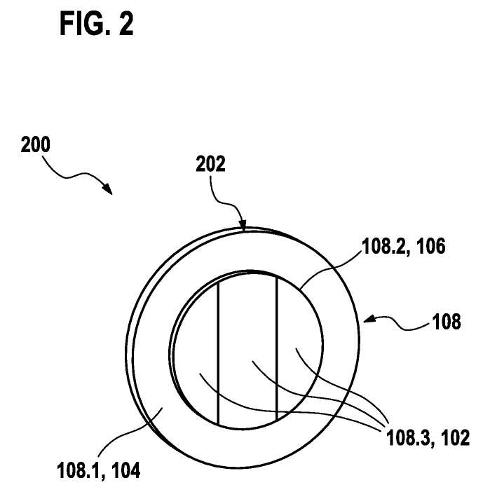

FIG. 2 shows a schematic diagram of an ultrasonic phased array sensor 200. The ultrasonic phased array sensor 200 shown in FIG. 2 has a geometric shape 202, wherein the geometric shape 202 has a circular base area. Furthermore, the ultrasonic phased array sensor 200 has a multi-layer structure 108. The illustrated multi-layer structure 108 has a first layer 108.1 which is formed from a membrane 104. A second layer 108.2 has a piezoelectric substrate 106, and a third layer 108.3, the inner layer, has three electrical contacts 102. The three electrical contacts 102 shown in FIG. 2 have different shapes.

For example, the geometric shape 202 of the piezoelectric substrate 106 can be square, rectangular, round, or elliptical. The number of electrical contacts 102 can also be increased or decreased as desired.

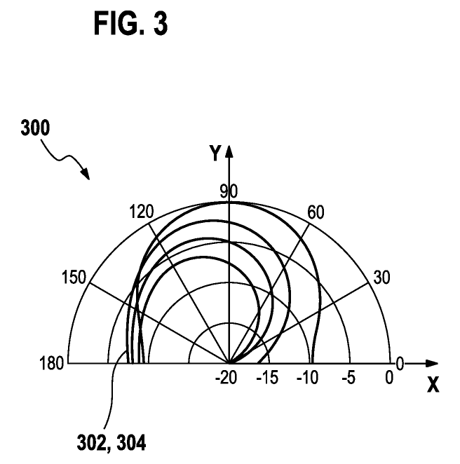

FIG. 3 shows a schematic diagram of a sound pressure level diagram 300. The sound pressure level diagram 300 has an X-axis representing the normalized sound pressure level X in [dB] and a Y-axis representing the angle in degrees, where the angle represents a directional characteristic Y of the ultrasonic phased array sensor 200. Furthermore, the sound pressure level diagram 300 shows four curve lines 304, wherein each individual curve line 304 represents a sound pressure level for a specific angle of an ultrasonic beam.

FIG. 3 shows a variation of the radiation from 0° (straight ahead) to 30° in 10° steps. These are only exemplary radiation angles, in order to illustrate the function.

The curve lines 304 are shown in polar coordinates. This allows a particularly good representation of the directional characteristic. The curve line 304 corresponds to a single-lobe curve.

For example, the curve lines 304 in FIG. 3 represent a change in the radiation direction 608 of ultrasound, which is caused by a phase shift among electrical contacts 102. Here each curve line 304 shown corresponds to a different radiation direction 608 in the diagram.

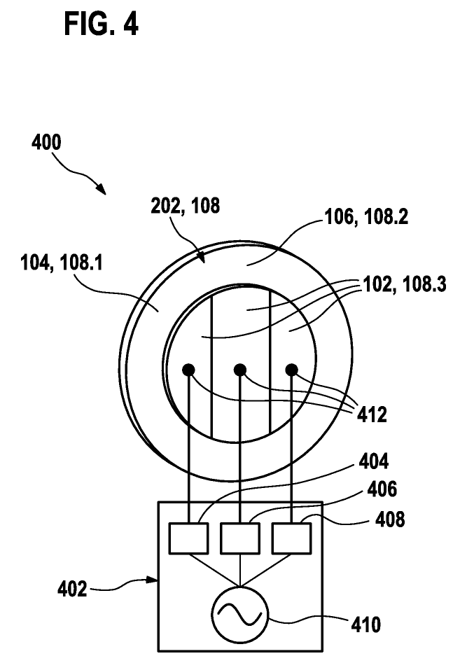

FIG. 4 shows a schematic representation of a phase shifter 400 that is connected to an ultrasonic phased array sensor 200. The ultrasonic phased array sensor 200 shown in FIG. 4 has the geometric shape 202 of a circular base area. Furthermore, the ultrasonic phased array sensor 200 has a multi-layer structure 108. The illustrated multi-layer structure 108 has a first layer 108.1 which is formed from a membrane 104. A second layer 108.2 has a piezoelectric substrate 106, and a third layer 108.3, the inner layer, has three electrical contacts 102. The three electrical contacts 102 shown in FIG. 4 have different shapes. Furthermore, an electronics system 402 is shown in FIG. 4. The electronics system 402 comprises a function generator 410, a phase shifter Phi_1404, a phase shifter Phi_2406, and a phase shifter Phi_3408. The outputs of the phase shifters 404, 406, 408 are electrically connected to the individual electrical contacts 102 of the ultrasonic phased array sensor 200.

A function generator 410 has a capacitance that can oscillate in a resonance of an electrical contact 102. Furthermore, the function generator 410 feeds a plurality of phase shifters 404, 406, and 408, which change the phase of the control signal. In this way, each electrical contact 102 is set into resonance with a different phase, and the resulting radiation direction 608 of the ultrasonic phased array sensor 200 can be changed.

For example, targeted control of the sound radiation can be achieved through a phase shift, in which for example the direction in which the ultrasound is radiated can be controlled and adjusted. The fact that the ultrasound can be directed specifically at a specific region or obstacle 602 represents an advantageous control option. A phase shift by a plurality of phase shifters 404, 406, and 408 can lead to a better image, for example an image of an obstacle height.

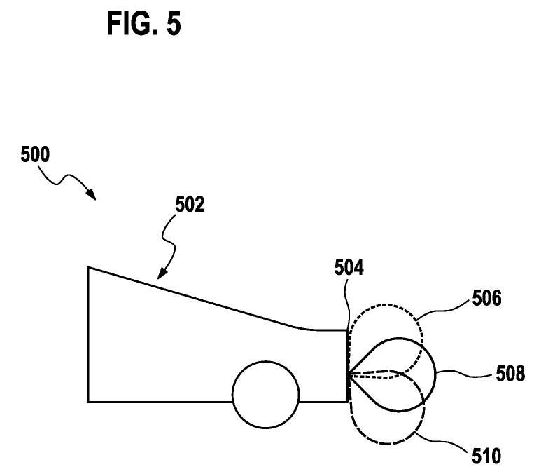

FIG. 5 shows a schematic representation of the radiation direction 608 of an ultrasonic phased array sensor 200 attached to a vehicle 502. The ultrasonic phased array sensor 200 is attached to a bumper 504. Furthermore, three radiation directions are shown, namely an upward radiation direction 506, a straight radiation direction 508, and a downward radiation direction 510.

For example, a radiation direction 608 of an ultrasound radiated by an ultrasonic phased array sensor 200 can be manipulated using an ultrasonic phased array sensor 200. In this way, a plurality of radiation angles can be created.

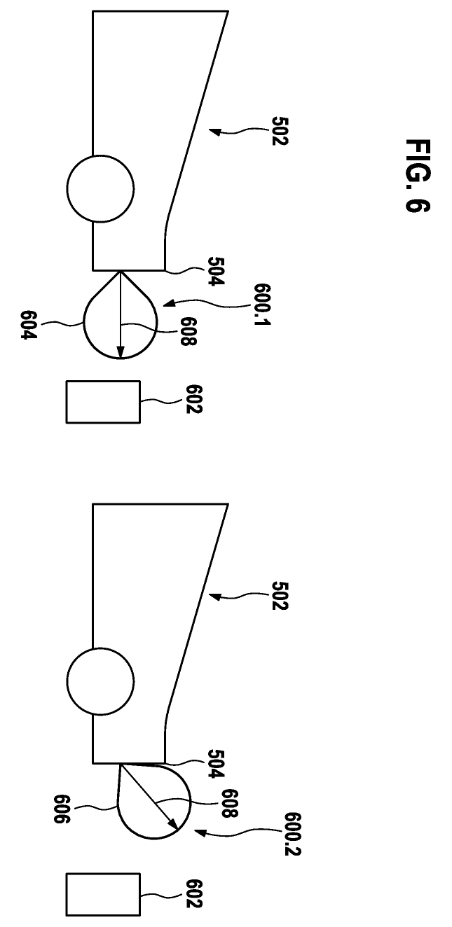

FIG. 6 shows a schematic representation of an obstacle height measurement with the representation of a straight-line radiation 600.1 onto an obstacle 602 and a curved radiation 600.2 around an obstacle 602. FIG. 6 also shows schematically the radiation direction 608 of an ultrasonic phased array sensor 200 attached on a vehicle 502. The ultrasonic phased array sensor 200 is attached on or in a bumper 504.

An example of this is the integration of one or more ultrasonic phased array sensors 200 into the bumper 504 of a vehicle 502. The ultrasound is sent directly in the direction of an obstacle 602 (straight-line radiation 600.1). Due to the straight-line radiation 600.1, a maximum echo is received from the obstacle 602. In order to now measure the height of the obstacle 602, the angle of the radiation direction 608 of the ultrasound is increased until it misses the obstacle 602. As soon as the ultrasound has passed by the obstacle 602, only a minimal receiving signal is detected and the height of the obstacle 602 can be estimated.

The present invention is not limited to the embodiments described here and the aspects emphasized therein. Rather, a large number of modifications are possible within the range of the present invention, which are within the scope of the activities of a person skilled in the art.

What is claimed is:

1. An ultrasonic phased array sensor, comprising:
a multi-layer structure including at least one first layer including a membrane, at least one second layer including a piezoelectric substrate, and at least one third layer including a plurality of electrical contacts;
wherein the electrical contacts are applied independently of one another on a surface of the piezoelectric substrate.

2. The ultrasonic phased array sensor according to claim 1, wherein the membrane is mechanically connected to the piezoelectric substrate.

3. The ultrasonic phased array sensor according to claim 1, wherein a radiation angle can be varied by a phase shift.

4. The ultrasonic phased array sensor according to claim 1, wherein a radiation direction can be controlled by phase shifting.

5. The ultrasonic phased array sensor according to claim 3, wherein the ultrasonic phased array sensor includes an obstacle height measurement by phase shifting.

6. The ultrasonic phased array sensor according to claim 1, wherein the ultrasonic phased array sensor is realized in a plurality of geometric shapes including round or rectangular or, elliptical or triangular or square.

7. The ultrasonic phased array sensor according to claim 1, wherein a number of the electrical contacts can be selected as desired.

8. The ultrasonic phased array sensor according to claim 1, wherein the electrical contacts are divided into individual electrically separated regions, wherein each of the individual regions or a plurality of the individual regions can be controlled separately.

9. The ultrasonic phased array sensor according to claim 1, wherein the membrane provides protection against environmental influences, wherein the membrane includes a moisture-resistant and dust-resistant material.

10. A method, comprising:
providing an ultrasonic phased array sensor, the ultrasonic phase array sensor including:
a multi-layer structure including at least one first layer including a membrane, at least one second layer including a piezoelectric substrate, and at least one third layer including a plurality of electrical contacts,
wherein the electrical contacts are applied independently of one another on a surface of the piezoelectric substrate; and
using the ultrasonic phased array sensor in an automotive application, wherein the ultrasonic phased array sensor is used as a parking sensor.
